(19) United States
(12) Patent Application Publication
(10) Pub. No.: US 2011/0069959 A1
(43) Pub. Date: Mar. 24, 2011

(54) OPTICAL INTERLEAVER AND DEINTERLEAVER

(75) Inventors: Fan Chen, Shanghai (CN); Zhenli Wen, Shanghai (CN); Fahua Lan, Shanghai City (CN); Kevin Dapeng Zhang, Fremont, CA (US)

(73) Assignee: FINISAR CORPORATION, Sunnyvale, CA (US)

(21) Appl. No.: 12/565,668

(22) Filed: Sep. 23, 2009

(51) Int. Cl. H04J 14/02

(52) U.S. Cl. 398/79

(57) ABSTRACT

Optical interleavers and deinterleavers. In one example embodiment, an optical deinterleaver includes first, second, and third filter cells interleaved with first and second waveplates. The filter cells are configured to filter optical signals propagating on first, second, and third paths of an optical loop. The optical deinterleaver also includes a retro reflector optically coupled with the filter cells and waveplates. The retro reflector is configured to reflect the optical signals between the first path and the second and third paths to form the optical loop. The optical deinterleaver further includes first, second, and third single-fiber collimators optically coupled to the first, second, and third paths of the optical loop, respectively.

### BACKGROUND

An optical interleaver is a three-port passive fiber-optic device that is used to interleave two sets of dense wavelength-division multiplexing (DWDM) channels (odd and even channels) into a composite signal stream. For example, an optical interleaver can be configured to receive two multiplexed signals with 100 GHz spacing and interleaves them to create a denser DWDM signal with channels spaced 50 GHz apart. An optical interleaver can also function as a deinterleaver by reversing the direction of the signal stream passing through the interleaver.

Optical interleavers have been widely used in DWDM systems and have become an important building block for optical networks with high-data-rate transmission. Optical interleavers are easier to manufacture in some respects compared to other bandpass filtering technologies, such as thin-film filters and arrayed waveguided gratings. With the increased demand for bandwidth from wideband, wireless, and mobile subscribers, conventional 50 GHz DWDM systems are increasingly unable to provide sufficient bandwidth.

### BRIEF SUMMARY OF SOME EXAMPLE EMBODIMENTS

In general, example embodiments of the invention relate to optical interleavers and deinterleavers. Some example embodiments increase the transmission capacity of long-haul DWDM optical communication systems.

In one example embodiment, an optical deinterleaver includes first, second, and third filter cells interleaved with first and second waveplates. The filter cells are configured to filter optical signals propagating on first, second, and third paths of an optical loop. The optical deinterleaver also includes a retro reflector optically coupled with the filter cells and waveplates. The retro reflector is configured to reflect the optical signals between the first path and the second and third paths to form the optical loop. The optical deinterleaver further includes first, second, and third single-fiber collimators optically coupled to the first, second, and third paths of the optical loop, respectively.

In another example embodiment, an optical deinterleaver includes first, second, and third filter cells interleaved with first and second half-waveplates. The filter cells are configured to filter optical signals propagating on first, second, and third paths of an optical loop. The optical deinterleaver also includes a retro reflector optically coupled with the third filter cell. The retro reflector is configured to reflect the optical signals between the first path and the second and third paths to form the optical loop. The optical deinterleaver further includes a first, second, and third single-fiber collimator optically coupled to the first, second, and third paths of the optical loop, respectively. The first single-fiber collimator is configured to carry an interleaved optical signal with about 10 Gb/s data in the odd channel and about 10 Gb/s data in the even channel with about 25 GHz channel spacing. The second single-fiber collimator is configured to carry a first deinterleaved optical signal with about 10 Gb/s data. The third single-fiber collimator is configured to carry a second deinterleaved optical signal with about 50 GHz channel spacing.

In yet another example embodiment, an optical deinterleaver includes a first, second, and third paths of an optical loop and a retro reflector configured to reflect the optical signals between the first path and the second and third paths to form the optical loop. The first path includes a single-fiber collimator, a first polarization beam displacer, first, second, and third filter cells interleaved with first and second half-waveplates, and a third half-waveplate positioned between the third filter cell and the retro reflector. The second path includes a fourth half-waveplate, the third, second, and first filter cells interleaved with the second and first half-waveplates, a first lateral shift prism, and a second single-fiber collimator. The third path includes the fourth half-waveplate, the third, second, and first filter cells interleaved with the second and first half-waveplates, a second lateral shift prism, and a third single-fiber collimator.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify certain aspects of the present invention, a more particular description of the invention will be rendered by reference to example embodiments thereof which are disclosed in the appended drawings. It is appreciated that these drawings depict only example embodiments of the invention and are therefore not to be considered limiting of its scope. Aspects of the invention will be described and explained with additional specificity and detail through the use of the accompanying drawings in which:

FIG. 1 is a front perspective view of an example optical deinterleaver;

FIG. 2A is a schematic top view of various internal components and a first path of an optical loop of the optical deinterleaver of FIG. 1;

FIG. 2B is a schematic right side view of various internal components of the optical deinterleaver of FIG. 1;

FIG. 2C is a schematic left side view of various internal components of the optical deinterleaver of FIG. 1;

FIG. 2D is a schematic top view of various internal components and a second path of the optical loop of the optical deinterleaver of FIG. 1;

FIG. 2E is a schematic top view of various internal components and a third path of the optical loop of the optical deinterleaver of FIG. 1;

FIG. 3 is a perspective view of an example pair of polarization beam displacers and half-waveplates of the example optical deinterleaver of FIG. 1;

FIG. 4 is a perspective view of an example filter cell of the example optical deinterleaver of FIG. 1;

FIG. 5 is a chart of the interleaving functionality of the example optical deinterleaver of FIG. 1; and

FIG. 6 is a chart of the insertion loss of the example optical deinterleaver of FIG. 1.

### DETAILED DESCRIPTION OF SOME EXAMPLE EMBODIMENTS

Example embodiments of the present invention relate to optical interleavers and deinterleavers. Some example embodiments can increase the transmission capacity of long-haul DWDM optical communication systems.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

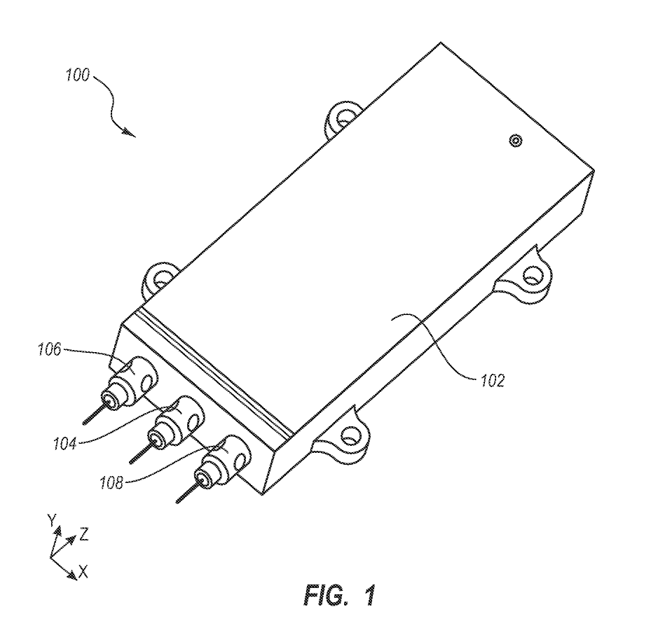

Reference is first made to FIG. 1 in which an example optical deinterleaver 100 is disclosed. As disclosed in FIG. 1, the example optical deinterleaver 100 includes a housing 102 and first, second, and third single-fiber collimators 104, 106, and 108.

In some example embodiments, the optical deinterleaver 100 is configured to receive at the first collimator 104 an interleaved optical signal with about 10 Gb/s data in the even channels and about 10 Gb/s data in the odd channels. The interleaved optical signal can have about 25 GHz channel spacing. The optical deinterleaver 100 is configured to detinterleave the interleaved optical signals and output through the second and third collimators 106 and 108 two about 10 Gb/s optical signals, each having about 50 GHz channel spacing.

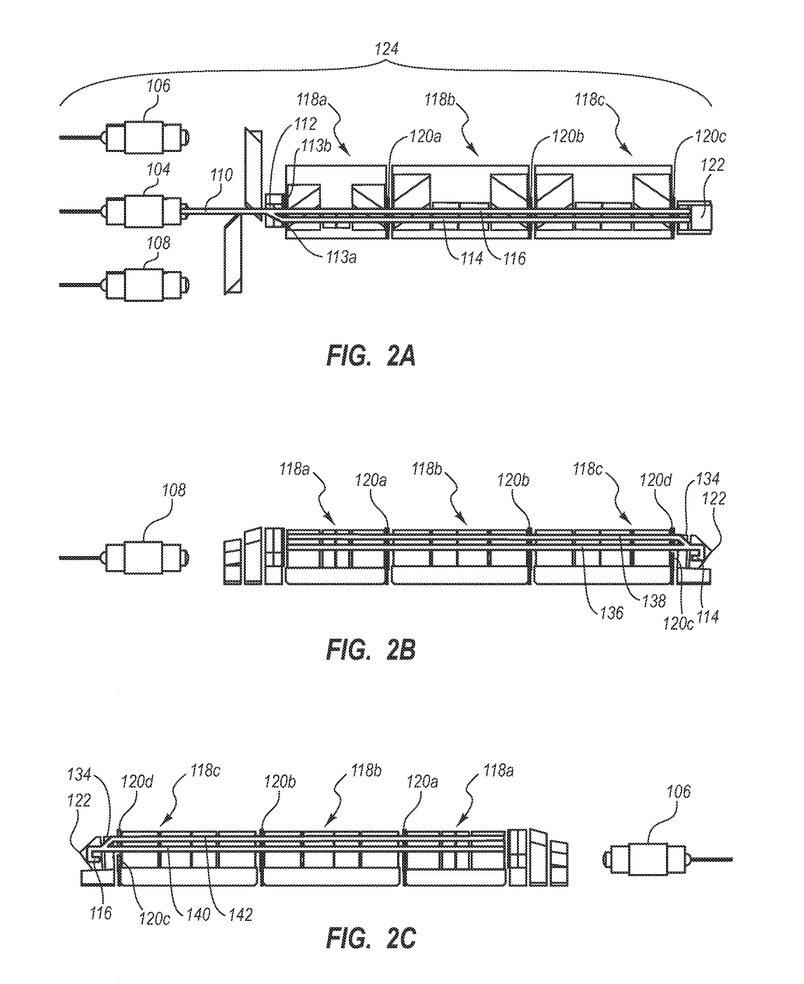

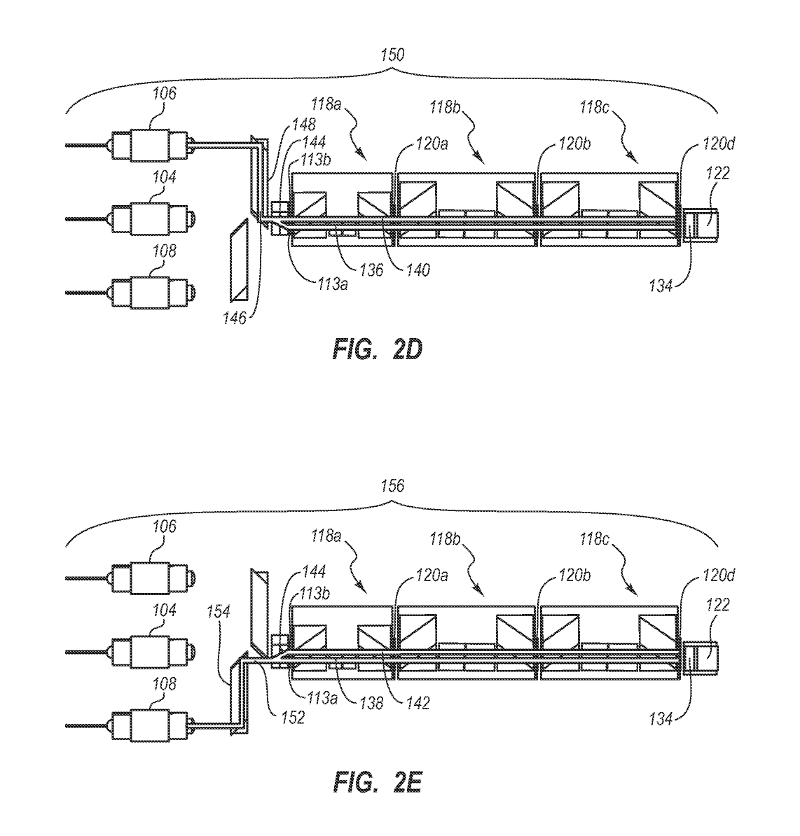

With reference now to FIGS. 2A-2E, additional aspects of the various internal components of the example optical deinterleaver 100 are disclosed. FIGS. 2A-2E disclose the example optical deinterleaver 100 without the housing 102. As disclosed in FIG. 2A, a single interleaved optical signal 110 enters the example optical deinterleaver 100 through the first collimator 104. The interleaved optical signal 110 includes about 10 Gb/s data in the even channels and about 10 Gb/s data in the odd channels. Next, the interleaved optical signal 110 passes through a first polarization beam displacer 112 and a waveplate assembly 113 attached to the first polarization beam displacer 112. The waveplate assembly 113 includes a right waveplate 113a and a left waveplate 113b. As disclosed in FIG. 2A and FIG. 3, the first polarization beam displacer 112 horizontally divides the interleaved optical signal 110 into a lower right beam 114 and a lower left beam 116. Next, the lower right beam 114 passes through the right waveplate 113a and the lower left beam 116 passes through the left waveplate 113b. In at least some example embodiments, the right half-waveplate 113a is oriented at about 22.5 degrees and the left half-waveplate 113b is oriented at about −22.5 degrees. As used herein, the term “oriented at” refers to the orientation of the optical axis angle of a waveplate crystal with respect to the horizontal line.

Next, as disclosed in FIG. 2A, the lower right and left beams 114 and 116 pass through a first filter cell 118a, a first half-waveplate 120a, a second filter cell 118b, a second half-waveplate 120b, a third filter cell 118c, and a third lower half-waveplate 120c. Then lower right and left beams 114 and 116 are reflected by a retro reflector 122. As disclosed in FIG. 2A, the elements 104, 112, 113a, 113b, 118a-118c, and 120a-120c make up a first path 124 of an optical loop of the optical deinterleaver 100.

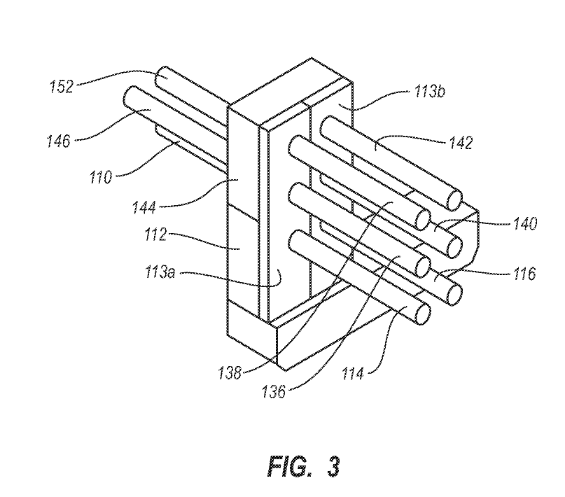

As disclosed in FIG. 4, each of the filter cells 118 disclosed in FIGS. 2A-2E includes opposing optical polarization beam splitters 126 and 128 displaced from one another by the wedge turners 130 and 132. In some example embodiments, the filter cells 118b and 118c are about 25 GHz cells, and the filter cell 118a is an about 50 GHz cell. Each of the filter cells 118a-118c can be similar to any of the “polarization beam splitting cells” or “optical filter cells” disclosed in U.S. Pat. No. 6,694,066, 6,850,364, or 7,173,763, each of which is incorporated herein by reference in its entirety.

As disclosed in FIGS. 2A-2E, the half-waveplates 120 enable the filter cells 118 to be mounted on bases that lie in the same plane by changing the polarization of the lower right and left beams 114 and 116. In at least some example embodiments, the first half-waveplate 120a is oriented at about 30 degrees, the second half-waveplate 120b is oriented at about 12 degrees, and the third lower half-waveplate 120c is oriented at about 4.5 degrees.

As disclosed in FIG. 2B and FIG. 3, after the lower right beam 114 is reflected by the retro reflector 122, the lower right beam 114 passes through a second polarization beam displacer 134. The second polarization beam displacer 134 vertically divides the lower right beam 114 into a middle right beam 136 and an upper right beam 138. Then, the middle and upper right beams 136 and 138 pass through a fourth upper half-waveplate 120d, the third filter cell 118c, the second half-waveplate 120b, the second filter cell 118b, the first half-waveplate 120a, and the first filter cell 118a. In at least some example embodiments, the fourth upper half-waveplate 120d is oriented at about 49.5 degrees.

Similarly, as disclosed in FIG. 2C, after the lower left beam 116 is reflected by the retro reflector 122, the lower left beam 116 passes through the second polarization beam displacer 134. The second polarization beam displacer 134 vertically divides the lower left beam 116 into a middle left beam 140 and an upper left beam 142. Then, the middle and upper left beams 140 and 142 pass through the third half-waveplate 120c, the third filter cell 118c, the second half-waveplate 120b, the second filter cell 118b, the first half-waveplate 120a, and the first filter cell 118a.

Next, as disclosed in FIG. 2D and FIG. 3, the middle right beam 136 passes through the right half-waveplate 113a and the middle left beam 140 passes through the left half-waveplate 113b. Then, the middle right beam 136 and the middle left beam 140 pass through a third polarization beam displacer 144. The third polarization beam displacer 144 horizontally combines the middle right beam 136 and the middle left beam 140 into a first output beam 146. Next, as disclosed in FIG. 2D, the first output beam 146 passes through a first lateral shift prism 148. The first lateral shift prism 148 is used to shift the first output beam 146 laterally to increase the distance between the second collimator 106 and the first collimator 104. Finally, the first output beam 146 exits the optical deinterleaver 100 through the second collimator 106. As disclosed in FIG. 2D, the elements 134, 118c-118a, 120d, 120b, 120a, 113a, 113b, 144, 148, and 106 make up a second path 150 of the optical loop of the optical deinterleaver 100.

Similarly, as disclosed in FIG. 2E and FIG. 3, the upper right beam 138 passes through the right half-waveplate 113a and the upper left beam 142 passes through the left half-waveplate 113b. Then, the upper right beam 138 and the upper left beam 142 pass through the third polarization beam displacer 144. The third polarization beam displacer 144 horizontally combines the upper right beam 138 and the upper left beam 142 into a second output beam 152. Next, as disclosed in FIG. 2E, the second output beam 152 passes through a second lateral shift prism 154. The second lateral shift prism 154 is used to shift the second output beam 152 laterally to increase the distance between the third collimator 108 and the first collimator 104. Finally, the second output beam 152 exits the optical deinterleaver 100 through the third collimator 108. As disclosed in FIG. 2E, the elements 134, 118c-118a, 120d, 120b, 120a, 113a, 113b, 144, 154, and 108 make up a third path 156 of the optical loop of the optical deinterleaver 100.

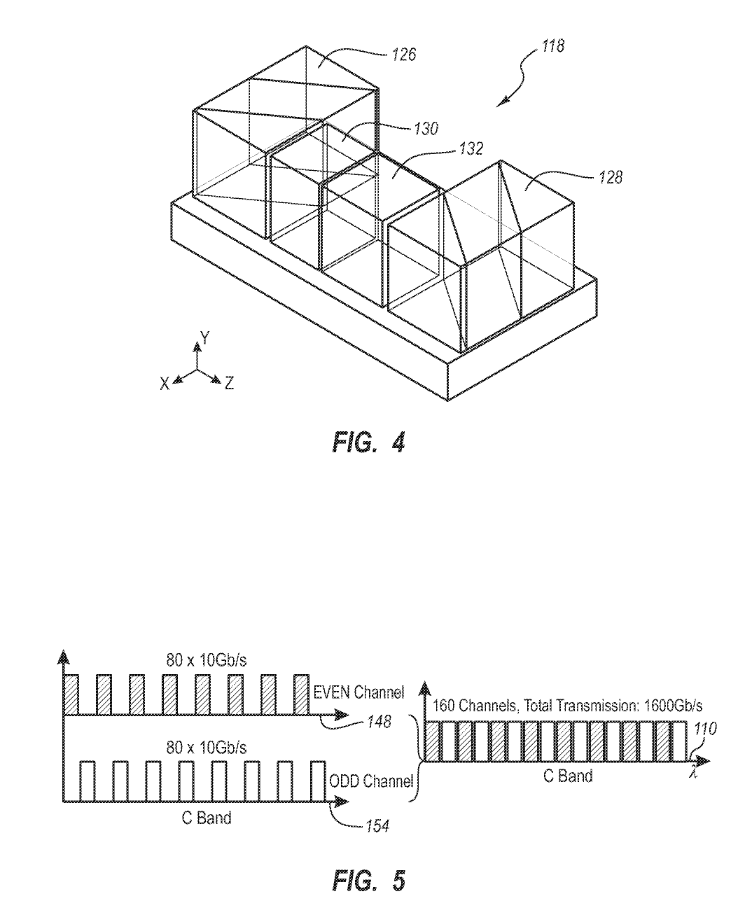

Although the example optical deinterleaver 100 has been discussed herein in terms of its deinterleaver functionality, it is understood that the deinterleaver 100 can also function as an interleaver. With reference now to FIGS. 2A, 2D, 2E, and 5, the first about 10 Gb/s beam 146 and the second about 10 Gb/s beam 152 can enter the optical deinterleaver 100 through the collimators 106 and 108, respectively, and then be combined into a single interleaved optical signal 110 that exits through the collimator 104. As disclosed in FIG. 5, reversing the direction of the signal stream passing through the optical deinterleaver 100 results in a total transmission capacity of 1600 Gb/s in the C Band.

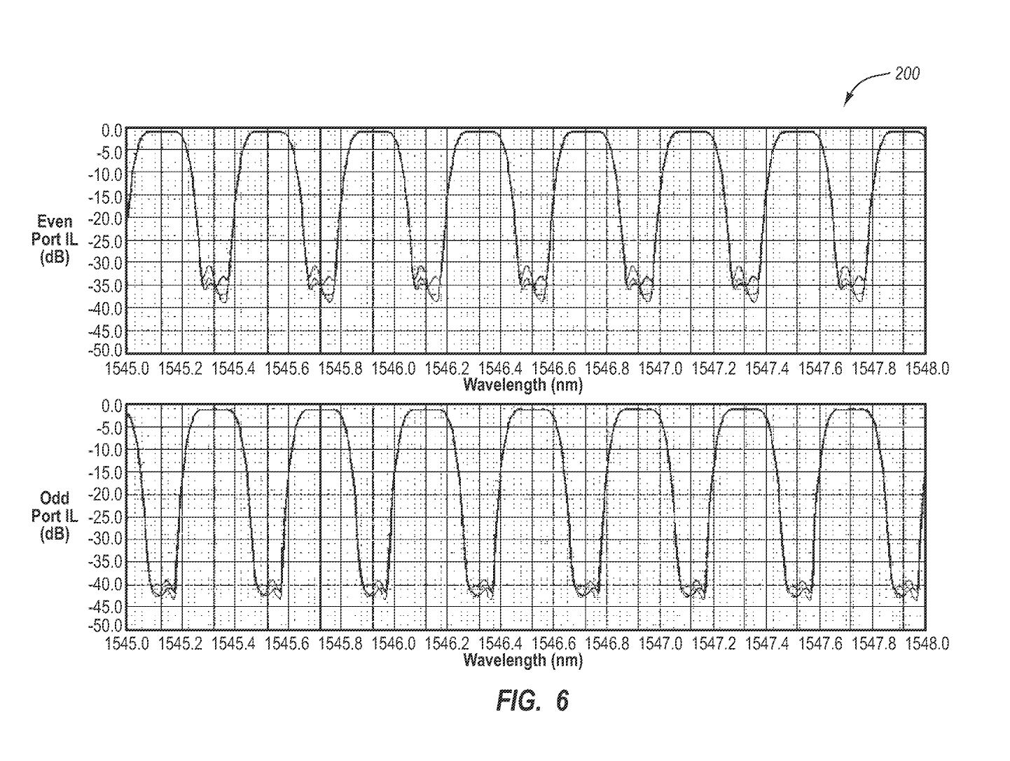

With reference finally to FIG. 6, a chart 200 of measured insertion loss of the example optical deinterleaver 100 of FIG. 1 is disclosed. In particular, the chart 200 demonstrates that the example optical deinterleaver 100 exhibits athermal and flat top about 25 GHz channel spacing.

The example embodiments disclosed herein may be embodied in other specific forms. The example embodiments disclosed herein are to be considered in all respects only as illustrative and not restrictive.

What is claimed is:

1. An optical deinterleaver comprising:
first, second, and third filter cells interleaved with first and second waveplates, the filter cells configured to filter optical signals propagating on first, second, and third paths of an optical loop;
a retro reflector optically coupled with the filter cells and waveplates, the retro reflector configured to reflect the optical signals between the first path and the second and third paths to form the optical loop; and
a first, second, and third single-fiber collimators optically coupled to the first, second, and third paths of the optical loop, respectively.

2. The optical deinterleaver as recited in claim 1, wherein the first single-fiber collimator carries a interleaved optical signal with about 10 Gb/s data in the odd channel and about 10 Gb/s data in the even channel with about 25 GHz channel spacing.

3. The optical deinterleaver as recited in claim 2, wherein the first filter cell is an about 50 GHZ filter cell, and the second and third filter cells are about 25 GHz filter cells.

4. The optical deinterleaver as recited in claim 3, further comprising:
a third waveplate optically coupled to the first path of the optical loop between the third filter cell and the retro reflector; and
a fourth waveplate optically coupled to the second and third paths of the optical loop between the retro reflector and the third filter cell.

5. The optical deinterleaver as recited in claim 4, wherein:
the first waveplate comprises a half-waveplate oriented at about 30 degrees;
the second waveplate comprises a half-waveplate oriented at about 12 degrees;
the third waveplate comprises a half-waveplate oriented at about 4.5 degrees; and
the fourth waveplate comprises a half-waveplate oriented at about 49.5 degrees.

6. The optical deinterleaver as recited in claim 4, further comprising:
a first polarization beam displacer optically coupled to the first path of the optical loop between the first single-fiber collimator and the first filter cell.

7. The optical deinterleaver as recited in claim 6, further comprising:
a second polarization beam displacer optically coupled to the second and third paths of the optical loop between the retro reflector and the fourth waveplate; and
a third polarization beam displacer optically coupled to the second and third paths of the optical loop between the first waveplate and the second and third single-fiber collimators.

8. The optical deinterleaver as recited in claim 7, further comprising:
a first lateral shift prism optically coupled to the second path of the optical loop between the third polarization beam displacer and the second single-fiber collimator;
a second lateral shift prism optically coupled to the third path of the optical loop between the third polarization beam displacer and the third single-fiber collimator; and
right and left half-waveplates optically coupled to the first, second, and third paths of the optical loop between the first and third polarization beam displacers and the first filter cell.

9. An optical deinterleaver comprising:
first, second, and third filter cells interleaved with first and second half-waveplates, the filter cells configured to filter optical signals propagating on first, second, and third paths of an optical loop;
a retro reflector optically coupled with the third filter cell, the retro reflector configured to reflect the optical signals between the first path and the second and third paths to form the optical loop;
a first single-fiber collimator optically coupled to the first path of the optical loop, the first single-fiber collimator configured to carry an interleaved optical signal with about 10 Gb/s data in the odd channel and about 10 Gb/s data in the even channel with about 25 GHz channel spacing; and
second and third single-fiber collimators optically coupled to the second and third paths of the optical loop, respectively, the second single-fiber collimator configured to carry a first deinterleaved optical signal with about 10 Gb/s data, and the third single-fiber collimator configured to carry a second deinterleaved optical signal with about 50 GHz channel spacing.

10. The optical deinterleaver as recited in claim 9, wherein the first filter cell is an about 50 GHz filter cell, and the second and third filter cells are about 25 GHz filter cells.

11. The optical deinterleaver as recited in claim 9, further comprising:
a third half-waveplate optically coupled to the first path of the optical loop between the third filter cell and the retro reflector; and
a fourth half-waveplate optically coupled to the second and third paths of the optical loop between the retro reflector and the third filter cell.

12. The optical deinterleaver as recited in claim 11, wherein:
the first half-waveplate is oriented at about 30 degrees;
the second half-waveplate is oriented at between about 12 degrees;
the third half-waveplate is oriented at about 4.5 degrees; and
the fourth half-waveplate is oriented at about 49.5 degrees.

13. The optical deinterleaver as recited in claim 11, further comprising:
a first polarization beam displacer optically coupled to the first path of the optical loop between the first single-fiber collimator and the first filter cell.

14. The optical deinterleaver as recited in claim 13, further comprising:
a second polarization beam displacer optically coupled to the second and third paths of the optical loop between the retro reflector and the fourth half-waveplate; and
a third polarization beam displacer optically coupled to the second and third paths of the optical loop between the first filter cell and the second and third single-fiber collimators.

15. The optical deinterleaver as recited in claim 14, further comprising:
a first lateral shift prism optically coupled to the second path of the optical loop between the first half-waveplate and the second single-fiber collimator;
a second lateral shift prism optically coupled to the third path of the optical loop between the first half-waveplate and the third single-fiber collimator; and
right and left half-waveplates optically coupled to the first, second, and third paths of the optical loop between the first and third polarization beam displacers and the first filter cell.

16. An optical deinterleaver comprising:
a first path of an optical loop, the first path comprising:
a single-fiber collimator;
a first polarization beam displacer;
first, second, and third filter cells interleaved with first and second half-waveplates; and
a third half-waveplate;
a second path of the optical loop, the second path comprising:
a fourth half-waveplate;
the third, second, and first filter cells interleaved with the second, and first half-waveplates;
a first lateral shift prism; and
a second single-fiber collimator;
a third path of the optical loop, the third path comprising:
the fourth half-waveplate;
the third, second, and first filter cells interleaved with the second, and first half-waveplates;
a second lateral shift prism; and
a third single-fiber collimator; and
a retro reflector configured to reflect the optical signals between the first path and the second and third paths to form the optical loop.

17. The optical deinterleaver as recited in claim 16, wherein the first single-fiber collimator carries a interleaved optical signal with about 10 Gb/s data in the odd channel and about 10 Gb/s data in the even channel with about 25 GHz channel spacing.

18. The optical deinterleaver as recited in claim 17, wherein the first filter cell is an about 50 GHz filter cell, and the second and third filter cells are about 25 GHz filter cells.

19. The optical deinterleaver as recited in claim 18, wherein:
the first half-waveplate is oriented at about 30 degrees;
the second half-waveplate is oriented at about 12 degrees;
the third half-waveplate is oriented at about 4.5 degrees; and
the fourth half-waveplate is oriented at about 49.5 degrees.

20. The optical deinterleaver as recited in claim 19, further comprising:
a second polarization beam displacer optically coupled to the second and third paths of the optical loop between the retro reflector and the fourth half-waveplate;
a third polarization beam displacer optically coupled to the second and third paths of the optical loop between the first filter cell and first and second lateral shift prisms; and
right and left half-waveplates optically coupled to the first, second, and third paths of the optical loop between the first and third polarization beam displacers and the first filter cell, wherein the right half-waveplate is oriented at about 22.5 degrees and the left half-waveplate is oriented at about −22.5 degrees.
